(19) United States
(12) Patent Application Publication
(10) Pub. No.: US 2010/0146434 A1
(43) Pub. Date: Jun. 10, 2010

(54) Minimap Navigation for Spreadsheet

(75) Inventors: Tomi Blinnikka, San Pablo, CA (US); Joseph Magnani, San Francisco, CA (US); Steven Horowitz, Oakland, CA (US)

Correspondence Address: MPG, LLP AND YAHOO! INC., 710 LAKEWAY DRIVE, SUITE 200, SUNNYVALE, CA, 94085, US

(73) Assignee: Yahoo!, Inc., Sunnyvale, CA (US)

(21) Appl. No.: 12/331,296

(22) Filed: Dec. 9, 2008

(51) Int. Cl. G06F 3/048

(52) U.S. Cl. 715/785; 715/781

(57) ABSTRACT

Methods and system for navigation in a data grid include defining a first region in a containment window of a display device associated with a computer system, to render data in a first data grid. The first data grid includes a plurality of rows and columns of data representing a portion of data in the data grid. A second region within the containment window provides a smaller, visual representation of the data in the data grid. The second region includes a two-dimensional data grid with a plurality of data portions with each data portion corresponding to a page of data in the data grid. Each of the plurality of data portions in the second region is provided with preview information to identify the content contained therein. A thumb tool within the second region enables selection and navigation to a coordinate point within a selected data portion within the second region using the two-dimensional data grid information. The selection and navigation to the selected coordinate point within the data portion in the second region enables rendering of the corresponding page of data in the first region. The data in the first region is a subset of the data in the second region and the data in the second region is a subset of the data in the data grid.

### BACKGROUND

1. Field of the Invention

The present invention relates to navigating large spreadsheets of data tables, and more particularly, to the usage of minimap in the navigation of spreadsheets.

2. Description of the Related Art

As more and more data is being made available on the Internet, access to the data is becoming a primary concern for various applications. Data available on the Internet can be represented in different ways, such as spreadsheet, data tables, data grids, text boxes, images, etc. Data available on spreadsheets and data tables are accessed through various application tools. As the amount of data in the data tables/spreadsheets increase, it is becoming increasingly challenging to render the data from a spreadsheet in a comprehensible manner on a display device of a computer system for users to interpret the data. Some applications have tried to circumvent this problem by providing a vertical, a horizontal or both a vertical and horizontal scrollbars for navigation. The user navigates through mounds of data oftentimes rendered beyond the visual portion of the display device using these navigational scrollbars. However, using vertical and horizontal scrollbars is time consuming and cumbersome as the user may have to first navigate horizontally and then vertically or vice versa to view the data. Further, the user might not get complete perspective of the underlying data. To maximize the benefit of horizontal and vertical scrolling, the user should have prior knowledge on the layout and content of the data in the datasheet. Otherwise, the user will have to wade through all the data to determine specific data that the user is looking for.

It is in this context that the embodiments of the invention arise.

### SUMMARY

Embodiments of the present invention provide methods and system for navigation in a data grid. A first region is defined within a containment window of a display device associated with a computer system, for rendering data using a first data grid. The first data grid includes a plurality of rows and columns for rendering data. The data in the first data grid represents a portion of data in the data grid. A second region within the containment window provides a smaller, visual representation of the data in the data grid. The second region includes a two-dimensional second data grid with a plurality of data portions with each data portion corresponding to a viewable page of data in the first data grid. Each of the data portions is defined by a corresponding row and column in the first data grid. Each of the plurality of data portions in the second region is provided with preview information to identify the content contained therein. A thumb tool within the second region enables selection and navigation to a selected data portion within the second region using the two-dimensional data grid information. The selection and navigation to the selected row and column coordinates in the data portion in the second region enables rendering of the corresponding page of data in the first region starting with the selected row and column. The data in the first region is a subset of the data in the second region and the data in the second region is a subset of the data in the data grid.

The embodiments of the present invention provide navigation to any data portion in the second region by identifying the two-dimensional coordinate information associated with the selected data portion. Each of the data portions within the second region represents a viewable page of data in the data grid. By using data portions to represent pages of data in the data grid, more data can be rendered at the second region and accessed at any given time. Providing a preview of content contained within a data portion enables a user to determine the content and location of corresponding data in the data grid, prior to the actual navigation. This enables a user to make more informed decisions with reference to navigation, making this a more efficient tool for representing and navigating large amounts of data. The embodiments are not limited to spread sheets or data grids, but can be extended to navigate any large document.

It should be appreciated that the present invention can be implemented in numerous ways, such as, methods, a system and an apparatus. Several inventive embodiments of the present invention are described below.

In one embodiment, a computer readable medium with computer executable instructions stored thereon, is disclosed. The computer executable instructions when executed on a computer system display a graphical user interface that enables navigation in a data grid. The graphical user interface includes a first region to render data in a first data grid. The first data grid includes a plurality of rows and columns of data that represents a portion of the data in the data grid. A second region within the graphical user interface provides a smaller visual representation of the data in the data grid. The second region includes a second data grid with plurality of rows and columns for rendering data portions representing a portion of data in the data grid. Each of the data portions in the second data grid represents a viewable page of data from the first data grid. Each of the data portions is defined by a corresponding row and column in the first data grid. A thumb tool within the second region is used to select and navigate to a selected data portion in the second data grid. The navigation to the selected row and column coordinates in a data portion enables rendering of the corresponding page of data from the first region starting with the selected row and column. Each of the data portions in the second data grid provides a preview of data contained therein to enable a user to determine the content of the data portion prior to navigating to the selected data portion and hence to the corresponding data in the data grid. The data rendered in the first region is a subset of the data contained in the second region which, in turn, is a subset of the data in the data grid.

In another embodiment, a computer readable medium with computer executable instructions stored thereon, is disclosed. The computer executable instructions when executed on a computer system display a graphical user interface that enables navigation in a data grid. The graphical user interface (GUI) includes a minimap region for rendering at least a portion of data from the data grid in a two-dimensional grid array. The data in the data grid is associated with at least a pair of coordinates to define location of data within the data grid. The data rendered in the minimap region includes a plurality of data portions rendered in a two-dimensional array. Each of the plurality of data portions stores a page of data from the data grid that can be rendered at a viewport region in a two-dimensional grid. The GUI further includes a data relocation tool defined within the minimap region. The data relocation tool is configured to select and to provide navigation to any selected data portion rendered in the minimap region. The data relocation tool uses the coordinates of the two-dimensional array of the minimap region to identify the location of the selected data portion and to provide the navigation. The navigation to the selected coordinates of the data portion in the minimap region enables rendering of the corresponding page of data from the data grid that is associated with the selected data portion, at the viewport region starting with the selected row and column.

In yet another embodiment of the invention, a method for navigating in a data grid is disclosed. The method includes providing a minimap region within a containment window of a computing system for rendering at least a portion of data from the data grid. The data is rendered at the minimap region in a two-dimensional grid as a plurality of data portions with each data portion in the minimap region representing a viewable page of data in the data grid. The minimap provides a smaller visual representation of the data in the data grid. Each of the plurality of data portions within the minimap region is defined by a row and column in the data grid and provides a preview of data contained therein. The method further includes defining a thumb tool within the minimap region to select and navigate to a selected data portion rendered within the minimap region. The navigation to the selected data portion is based on the selected row and column coordinates. The page of data corresponding to the selected data portion in the minimap region is retrieved from the data grid and rendered at a viewport region upon selection and navigation, starting with the selected row and column of the selected data portion. The data is rendered in a two-dimensional grid and provides comprehensive information of data contained therein.

The embodiments of the invention provide an alternate way to enable navigation in a data grid. The small minimap region provides a visual representation of the underlying pages of data in the data grid enabling access to a large amount of data within a small area. Further, the two-dimensional representation of data in the minimap region enables navigation using a single action instead of navigation using two or more actions. The preview functionality built into each of the data portions in the minimap region enables determining the content of the data portion prior to navigating and rendering at the viewport region making this a more efficient tool for navigation.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings.

FIG. 1 illustrates a simplified representation of a page of data in a viewport region of a containment window, in one embodiment of the invention.

FIG. 2 illustrates a simplified minimap region with some of the tool tips provided for identifying data contained within, in one embodiment of the invention.

FIGS. 3A-3D illustrate a simplified representation of a thumb tool within a minimap region enabling automatic scrolling of data rendered in the minimap region, in one embodiment of the invention.

FIG. 4 illustrates a sample viewport region used for rendering a data grid of TV listings, in one embodiment of the invention.

FIG. 5 illustrates a flowchart of process operations involved in navigating a data grid, in one embodiment of the invention.

### DETAILED DESCRIPTION

Broadly speaking, the embodiments of the present invention provide methods and systems for navigating a data grid by defining a minimap region within a containment window of a display device of a computer system to render a portion of data from the data grid. The data in the minimap region is associated with a corresponding row and column in the data grid. A thumb tool is defined within the minimap region to select and navigate to various data portions rendered within the minimap region. The corresponding data associated with the selected row and column coordinates of the data portion within the minimap region is rendered at a viewport region defined within the containment window. The viewport region displays the page of data representing the selected data portion in the minimap region starting with the selected row and column.

Towards this end, different ways for navigating through data in a data grid is provided. The data grid includes large amounts of data represented using at least a pair of coordinates. To begin with, a portion of data from the data grid is selected for rendering at a viewport region of a containment window in a two-dimensional grid. The data in the data grid may be of any type that can be represented in a grid format and identified using at least a pair of coordinates. A minimap region is defined within the containment window to render portions of data from the data grid in a two-dimensional grid using row and column coordinates. The minimap region represents a small visual representation of the data in the data grid. A small thumb tool is defined within the minimap region for selecting and navigating to a selected data portion within the minimap region. The thumb tool uses the coordinates to identify and navigate to the location of the data portion in the minimap region and to the corresponding data in the data grid. The data for the selected data portion is retrieved from the data grid and rendered at the main viewport region of the containment window starting with the selected row and column. A preview feature available to the thumb tool and at the minimap region enables identifying contents of the data portions prior to the actual selection and navigation to any data portion within the minimap region so that a user may be able to make informed decisions while navigating through the data in the data grid.

Thus, the embodiments enable navigating through a large data grid that is represented in at least a two-dimensional data array. The preview functionality helps in determining the contents prior to the actual navigation. Additional features, such as tool tips and scrolling at the minimap region enable for faster and more precise access to large amount of data in the data grid.

It should be understood that the features of the embodiments may be in the form of a navigation tool having computer executable instructions that can be executed on a computer system. The computer executable instructions of the navigation tool do not have to be integrally coupled to the computer system but be available to the computer system. Towards this end, the various features and functionalities of the current embodiments will now be described in detail with reference to the drawings.

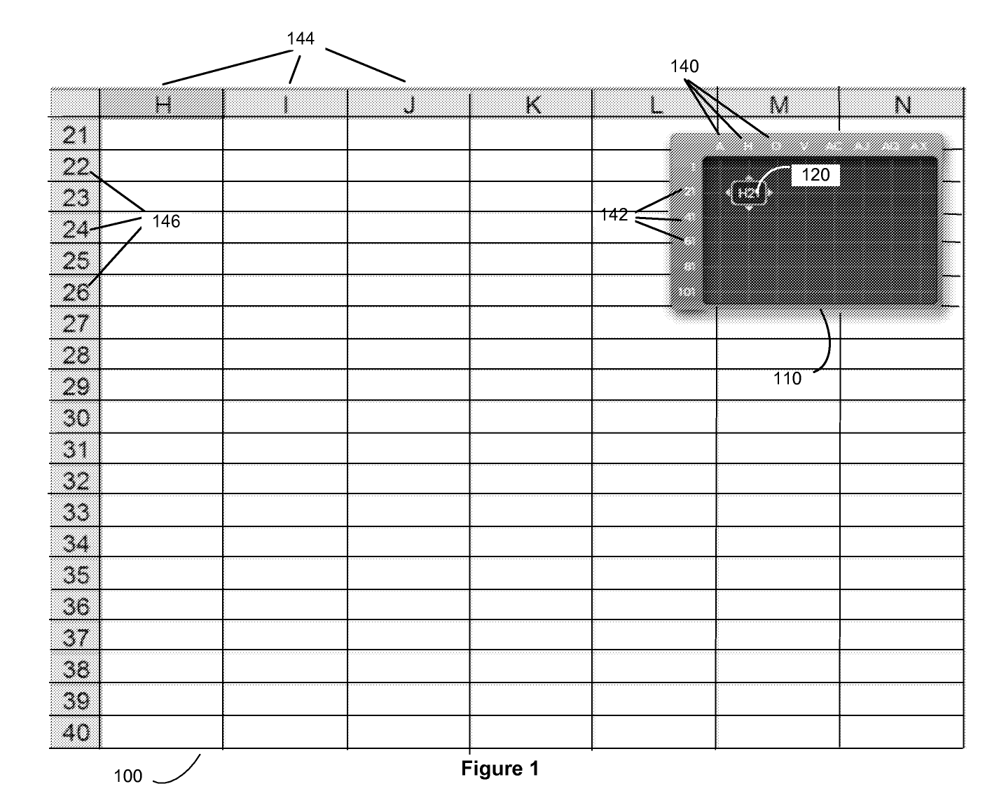

FIG. 1 illustrates a simplified representation of data from a data grid in a viewport region 100, in one embodiment of the invention. The viewport region 100 is a displayable region within a containment window of a display device of a computer system. The data in the viewport region 100 is presented in a two dimensional array that is representative of the underlying data in the data grid. The data grid, in turn, represents a large amount of data, such as TV listings, data tables, spreadsheet, etc., that go beyond the realm of viewable data on a display device. In order to access the data that is beyond the viewable data on a display device, a minimap region 110 is defined within the containment window. The minimap region 110 may be defined within the viewport region 100 of the containment window, as illustrated in FIG. 1, or may be defined within the containment window but outside of the viewport region 100. Further, the location of the minimap region 110 is not fixed at a specific location but can be rendered based on the type of data being rendered and on the preferences of a user. Thus, the location of the minimap region 110 may be defined to be at the right or left side at the top or bottom corner of the viewport region 100 or anywhere within the containment window so long as the data in the viewport region 100 can be substantially viewed. The location of the minimap region can be customized through a user option.

The minimap region 110 includes portions of data that are representative of the data in the data grid. As a result, the data in the minimap region 110 includes data portions rendered in two-dimensional array similar to the data rendered in the viewport region 100. Each of the data portion in the minimap region 110 encompasses a page of data in the data grid and is defined by a corresponding row and column in the data grid. By representing a page of data in a data portion of the minimap region 110, large amounts of data can be visually captured within a small window enabling easy access to the large amounts of data of the data grid. The two dimensional array includes a plurality of rows and columns. Each column is defined by a column header 140 and each row is defined by a row header 142. A tooltip may be used to provide identification information for the data contained within each data portion and for each column header 140 and row header 142 in the minimap region. The tooltip is a common graphical user interface (GUI) element used in conjunction with a pointer to identify any supplementary information associated with data when hovering over the data. The supplementary information associated with the data, in one embodiment, may include a label that identifies the data contained therein.

A page of data from the data grid is originally rendered at the viewport region 100. The data is rendered in a two-dimensional grid containing a plurality of rows and columns and is representative of the underlying data in the data grid. Each of the columns in the viewport region 100 includes a column header 144 and each of the rows includes a row header 146. The data rendered in the viewport region 100 corresponds to a data portion within the minimap region 110. A user may select a different data portion for rendering based on the identifying information provided at each data portion, at which time corresponding data from the data grid is rendered at the viewport region 100. Additionally, a user may use the column header 140 or row header 142 to jump to specific data portion corresponding to the selected column or row. For instance, the data grid may include data corresponding to TV channel listings with the rows corresponding to TV channels and the columns corresponding to days of the week. The user may wish to view TV show listing for a Thursday of a particular week instead of a Monday that is currently rendered at the viewport region. The user selects the column header for Thursday in the minimap region, at which time, the data from the Thursday listings will be selected using the coordinates and rendered at the viewport region 100.

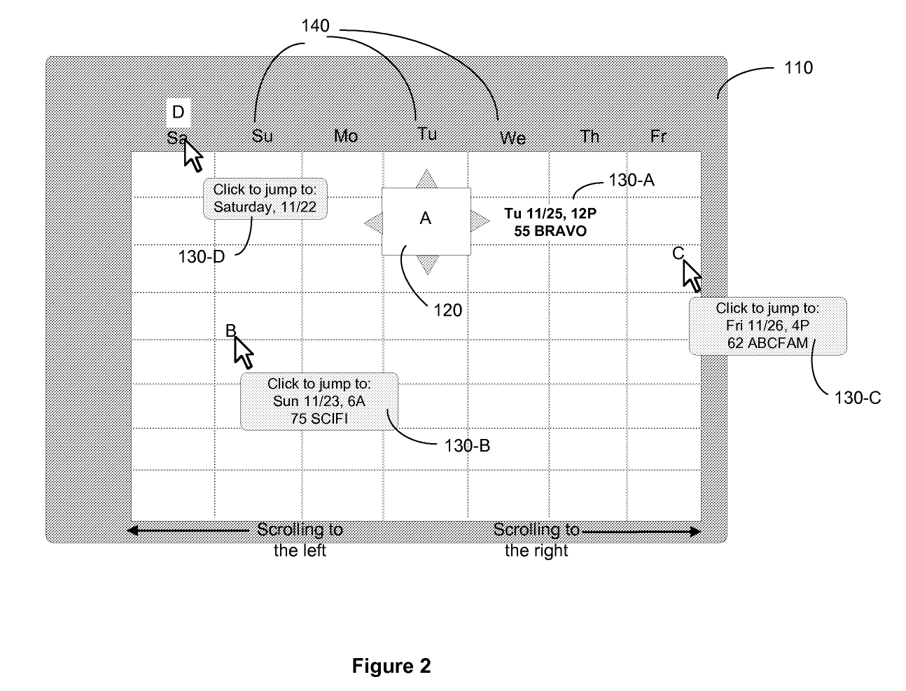

FIG. 2 illustrates the minimap region that defines this feature, in one embodiment of the invention. The minimap region shows a plurality of rows and columns with each rectangle in the minimap region defining a data portion that is representative of a page of data in the data grid. Each data portion is defined by corresponding row and column coordinates. As shown, each of the columns in the minimap region is associated with a column header 140. A thumb tool 120 at the minimap region identifies the data portion using the row and column coordinates and the corresponding identification information is provided as a tooltip 130-A. Data associated with the corresponding data portion is rendered at the viewport region of the containment window (not shown). In the embodiment illustrated in FIG. 2, the viewport region renders Tuesday's TV listing corresponding to the data portion selected by the thumb tool 120 for rendering. Upon rendering of the data, the user may wish to navigate to a specific time on a particular day, such as 6 AM on a Sunday or 4 PM on a Friday of the week currently being rendered, or may wish to navigate to view the TV listings for a particular day, such as a Saturday. As the user moves the cursor to each data portion containing points B or C, or the column header D, the corresponding tooltip 130-B, 130-C or 130-D provides the identifying information for the data contained therein so that the user may be able to determine which data portion the user wants to navigate to and the selected data is rendered at the viewport region based on the coordinates of the selected data portion.

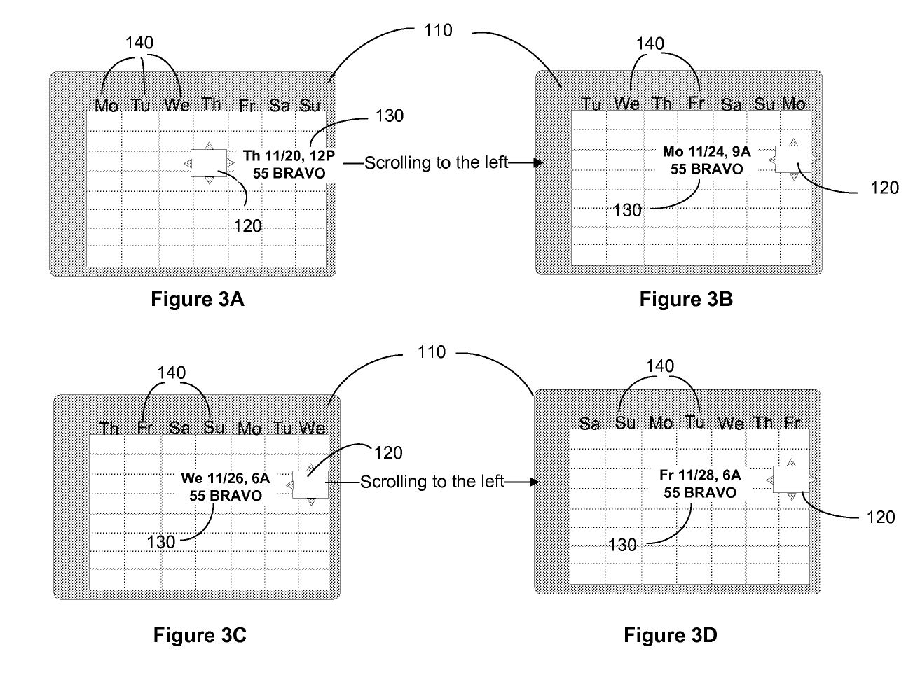

The navigation tool enables storing of additional data than what can be represented in the visual portion of the minimap region 120 by defining a scrolling feature. FIGS. 3A-3D illustrate the scrolling feature that is used in navigating the data grid. The scrolling feature allows a user to scroll to data regions beyond the visual portion of the minimap region in order to access the additional data. As illustrated in FIG. 3A, a user has selected a data portion from a visual portion of the minimap region using the thumb tool 120. Eventually, if the user would like to view data from a region beyond a visual portion of the minimap region, the scrolling feature enables the user to move the thumb tool 120 to an edge of the data region within the visual portion of the minimap region 110 and the rows will scroll up or down and the columns will scroll to the right or left based on which edge the thumb tool 120 is positioned revealing the data portions from beyond the visual portion of the minimap region. For instance, if the thumb tool is placed at the right edge of the minimap region, as shown in FIGS. 3B, 3C and 3D, the columns will scroll to the left revealing data portions from the right side of the minimap region that is beyond the visual portion of the minimap region. Similarly, if the thumb tool 120 is positioned to the left edge of the minimap region, the columns will scroll to the right revealing data portions from the left side of the minimap region that is beyond the visual portion of the minimap region. In addition to the scrolling feature, the navigation tool provides a tooltip 130 to identify corresponding data portion as the user scrolls through the data portions. The location of the tooltip 130 switches based on the location of the thumb tool 120 so that the identification information rendered at the minimap region is always within the visual portion of the minimap region.

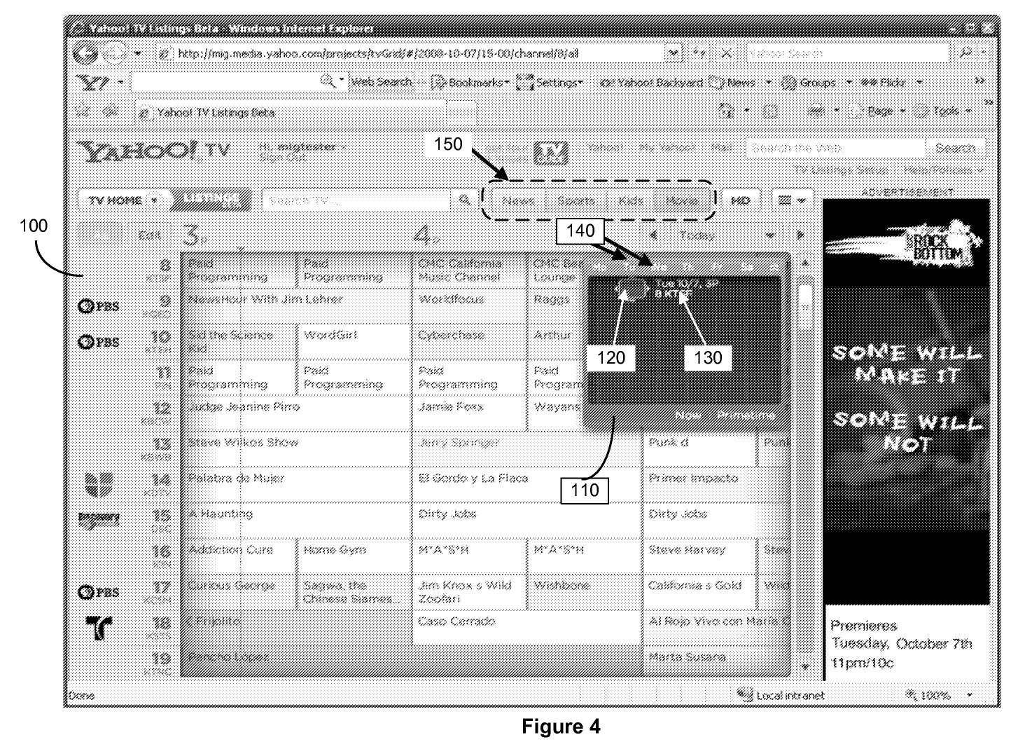

FIG. 4 illustrates a sample rendering of a data grid in a viewport region 100 of a containment window of a computer system. The viewport region 100 currently displays data from TV listings in a two-dimensional array. A minimap region 110 providing a smaller visual representation of underlying data in the data grid is defined within the viewport region 100. Although the embodiment discloses the minimap region within the viewport region, the location of the minimap region is exemplary and is not restrictive. Consequently, the minimap region can be located anywhere within the containment window. The underlying data in the data grid is represented using at least a pair of coordinates and is rendered at the minimap region 110 as a plurality of data portions in a two dimensional grid of rows and columns. A thumb tool 120 is defined within the minimap region 110 to select and navigate to a data portion in the minimap region. The number of rows and columns in the minimap region 110 may vary based on the underlying data and the level of user customization allowed. In one embodiment, the number of rows and columns are rendered based on pre-defined row and column resolution. The row and column resolutions are pre-defined based on the underlying data and may be customized by a user. For instance, in the case of TV listings, the number of pre-defined columns considered for rendering in the minimap region may encompass two weeks of TV listings data with the visual portion covering at least one week of TV listings data. In one embodiment, the number of columns in the visual portion may be customizable to display 5 days worth of data. In another embodiment, the number of columns may be defined and may not be customizable. In one embodiment, the number of rows may be pre-defined based on the viewing clarity desired by the user. In another embodiment, the number of rows may be dynamically determined based on the underlying data. In this embodiment, the number of rows in the minimap region adjusts as the amount of underlying data increases or decreases. The number of columns may, however, remain constant based on the pre-defined column resolution option and level of customization allowed in order to provide a proper perspective of the underlying data. Thus, for instance, in the case of a TV listings data grid, the number of columns within the minimap region may be fixed to reflect a weekly or monthly rendition of TV channels while the number of rows may be varied to reflect the amount of data within the data grid for the selected data portion. This may entail skipping certain time periods where there are no shows scheduled while the column listing may include all days even when there are no shows scheduled for certain days. Additionally, when there are more rows than can be accommodated in the minimap region, the rows can be scrolled using the scrolling feature and the rows may be displayed in the minimap region in increments based on the pre-defined row resolution. For instance, where there are more rows than can be accommodated in the minimap region (say 100 rows), a set number of rows (say 50 rows) are rendered initially and the additional rows of information may be rendered in increments (of 10) based on the pre-defined row resolution (10% of data).

A thumb tool 120 identifies the data portion selected for rendering at the viewport region within the main containment window. A tooltip 130 is rendered alongside the thumb tool providing the identification information of data contained in the selected data portion that is currently rendered at the viewport region 100. In addition to the tooltip, the data rendered at the minimap region includes column headers 140, as shown in FIG. 4. The column headers 140 are provided with “jumpto” link options to quickly jump to the corresponding data portions as and when they are selected. The column headers are also provided with tooltip features to identify the data contained under each column. In the embodiment illustrated in FIG. 4, row headers are not shown within the minimap region 110. It should be noted that the embodiment of FIG. 4 is exemplary and should not be considered restrictive. The navigation tool displaying the graphical user interface can be extended to include row headers in the minimap region with row headers provided with “jumpto” link options to quickly jump to a particular row. It should be noted that the tooltip functionality may be set up to allow for displaying or hiding the tooltip feature so that the corresponding information may be displayed or hidden when hovering over the data portions, column headers or row headers.

The thumb tool 120 provides the ability to lock into a specific row and column when navigating through the various data portions in the minimap region using the row and/or column coordinates. This feature enables horizontal and vertical navigation within the minimap region. In one embodiment, engaging a shift key while activating a mouse could enable activating the locking feature. In this embodiment, upon locking to a selected row and column, the user can navigate easily along the selected row or selected column while the shift key and mouse are engaged. The locking feature can be reset by disengaging any one of the shift key, mouse or both the shift key and the mouse. It should be noted that the navigation within the minimap region can be accomplished either by dragging the thumb tool to the desired data portion, including a column header and a row header, or by clicking a mouse at the desired location. The dragging operation can be live or delayed. In a live dragging operation, as the thumb tool is engaged and dragged across data portions, the corresponding data is rendered in the viewport region within the containment window reflecting the data in the data grid corresponding to the selected data portion of the minimap region. Each location in the minimap region identifies data portions with column/row markers, such as column/row coordinates, or page markers. In a delayed dragging operation, the data in the viewport region is updated after disengaging the thumb tool. In this instance, the thumb tool is engaged, moved to a new location within the minimap region and then disengaged to indicate the selected data portion. Upon disengagement of the thumb tool the corresponding data from the selected data portion is rendered at the viewport region. Based on the amount of data to be optimized and rendering performance requirements, the thumb tool can be appropriately programmed to include either a live or a delayed option. The aforementioned embodiments have been described for textual data being represented in a two-dimensional array. However, the embodiments are not restricted to textual data but can be extended to represent an image thumbnail of the contents. In the case of image thumbnail, the different portions of the image thumbnail can be identified using a pair of coordinates.

The minimap region may also include “stabilizing” functionality in order to stabilize a click within a threshold level. When a user clicks in the background of the minimap region outside the thumb tool, depending on where the user clicks, the stabilizing functionality will determine the location the user desires to move and move the thumb tool accordingly. For instance, the data within the minimap region may be associated with TV listings and a Thursday listings may be currently selected for rendering at the viewport region. When the user clicks in the background section of the minimap region just below the thumb tool, the stabilizing functionality will recognize the click to be roughly inline with the thumb tool vertically and will effectively scroll down the data grid in the minimap region to the desired location. The stabilizing functionality may use a function, such as a “snap to grid” function, to determine a desired location of navigation and navigate the thumb tool accordingly. Additional features, such as row/column “stickiness” feature, may be used for navigating to a subsequent location within the minimap. For instance, if the stickiness feature is turned on, the thumb tool may have to be moved a certain pre-defined fixed distance from a current row or column in order to recognize the new location of the thumb tool and navigate to the new location.

The number of rows and columns in the minimap region dynamically adjust to the amount of data in the data grid based on one or more filtering options 150 available at the minimap region. For instance, when the amount of data in the data grid is large, the number of rows of data for rendering the data increases to accommodate the data from the data grid. Similarly, if there is less data available at the data grid, the number of rows rendered in the minimap region is less. The filtering options 150 may be driven by the nature of the data in the data grid and can be customized through one or more user options. For instance, with reference to the TV listings data grid illustrated in FIG. 4, the number of rows rendered in the minimap region when the filter option 150 “All” is chosen provides a plurality of rows to reflect the amount of underlying data as opposed to “News” or “Sports” or any other filtering option 150. The number of rows and columns in the minimap region can be customized to properly represent the underlying data based on one more filtering options 150 available at the minimap region. For instance, for TV listings, it would be desirable to have all days of a week represented in the minimap region and the number of rows can be adjusted based on the amount of data a user desires to view at any given time. The TV listings may include additional weeks of data beyond what is rendered at the viewable portion of the minimap to allow a user to scroll across. Similarly, when data from a spreadsheet is represented in a minimap, it might be desirable to view data across all rows as opposed to all columns in which case the minimap region will be customized to reflect more row details as opposed to column details. Thus, the number of rows and columns rendered in the minimap region is driven by the amount of the underlying data in the data grid based on the filtering options and rows and columns are displayed or hidden accordingly.

The viewport region is part of a visual portion of the containment window and the containment window may include additional informational data, such as advertisements. The additional information rendered in the containment window may be content based or user based. In one embodiment, the size of the minimap region is fixed and does not change when the viewport region or the containment window is re-sized. Keeping the size of the minimap region constant enables the user to easily view the details of the data portion contained therein.

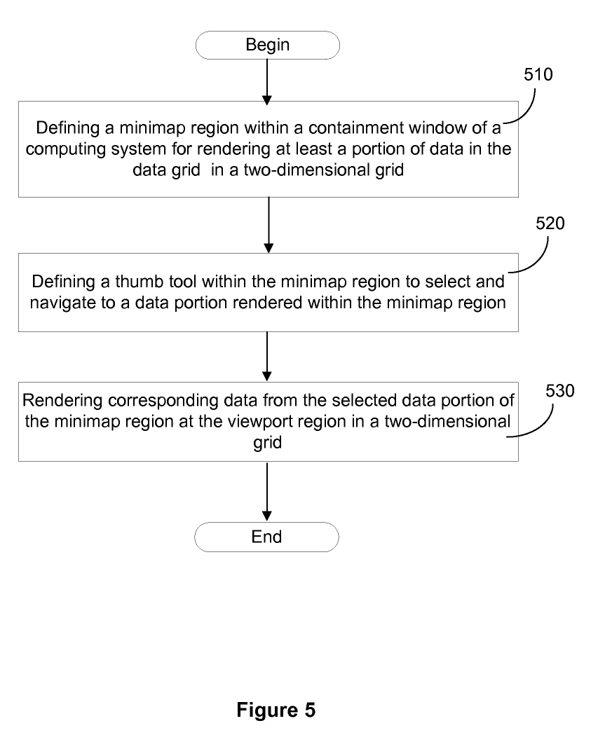

With the above detailed description of the various embodiments, a method for navigating a data grid will now be described with reference to FIG. 5. The method begins at operation 510, wherein a minimap region is defined within a containment window of a computer system for rendering at least a portion of data in the data grid. The minimap region renders the data as a plurality of data portions in a two-dimensional grid represented using row and column coordinates. Each of the data portions represents a page of data in the data grid and is defined by a row and column in the data grid. A preview of the underlying data in each data portion at the minimap region is enabled. A viewport region is defined within the containment window to render selected data from the data grid starting with the row and column defined by the corresponding coordinates of the selected data portion. The data rendered in the viewport region corresponds to a data portion in the minimap region. The minimap region is incorporated within the containment window and may be included within or outside the viewport region rendered at the containment window. The minimap region may be located anywhere within the containment window including anywhere within the viewport region when the minimap region is incorporated within the viewport region. The data in the data grid may be any type of data, including textual data and image data, that can be rendered in a two dimensional grid. The data associated with the minimap region may include additional data portions that are rendered beyond the visual portion of the minimap region and can be accessed by scrolling to the appropriate location in the minimap region. The data from the data grid used in the rendering of data portion in the minimap region is filtered based on one or more filtering options available at the data grid.

A thumb tool is defined within the minimap region to select and navigate to a data portion rendered within the minimap region, as illustrated in operation 520. The thumb tool can be defined in various different ways, such as a rectangle box or a distinct highlighted portion, to identify a selected data portion within the minimap area. The thumb tool is used to navigate to any location within and outside of a visual portion of the minimap area by using a scrolling function defined within the minimap region. The scrolling function is activated when the thumb tool is positioned at the right or left edge of the minimap region so that the data portions outside of the visual portion of the minimap may be accessed.

As the user navigates to corresponding coordinate points of the various data portions within the minimap region, the corresponding data from the selected data portions are rendered at the viewport region within the containment window starting with the corresponding row and column of the selected data portion, as illustrated in operation 530. The data from the selected data portions is rendered in a two-dimensional array reflecting the data in the data grid. The data is identified using at least a pair of coordinates, such as row marker or column marker. The row and/or column marker indicators are dynamically calculated using the row and column coordinates. The row and/or column marker indicators may be displayed in the minimap region as row/column headers during relocation of the thumb tool, may be rendered at all times or may be rendered only when the thumb tool is moved. As the thumb tool is moved/dragged across the minimap region or a location is clicked in the background section of the minimap region outside the thumb tool, the corresponding data from the selected data portions are identified based on the row and column coordinates within the minimap region and retrieved from the data grid. The clicking or selection enables location of a point within the minimap using the coordinates and the corresponding data is identified from the data grid using these coordinates. A viewable page of data is dynamically generated using the identified data which is then rendered at the viewport region starting with the corresponding row and column of the selected data portion based on the option associated with a drag operation available at the thumb tool. The options available for a drag operation include “live” or delayed drag operation. When the drag operation is live, the underlying data corresponding to the selected data portion is rendered immediately at the viewport region while the thumb tool is still engaged. When the drag operation is delayed, the corresponding data to the selected data portion is rendered at the viewport region after the thumb tool is disengaged. The drag operation option is selected based on the level of optimizing of data and rendering performance required at the viewport region.

As explained earlier, the number of rows and columns of data rendered in the minimap region is dynamically defined based on a user's preference and the amount of underlying data. For instance, in a TV listings application, the minimap region may be configured to include seven columns to accommodate the days of the week and ten rows for TV channels. Based on the amount of data corresponding to the data portion, the number of rows may dynamically adjust to accommodate the amount of TV listings for that day. For instance, the number of TV channels satisfying a filtering option for Sunday may exceed the 10 rows that are defined for the minimap region. In such case, all 10 rows of data are rendered at the minimap region and the user may be provided with an option to scroll down using the thumb tool to access the additional data available for Sunday. Similarly, if the total number of TV channels for Monday satisfying the filtering option is six, then the number of rows within the data grid in the minimap region is dynamically adjusted to represent the six channels. Thus, based on the underlying data and the filtering options defined for the underlying data, the data grid in the minimap region is dynamically adjusted to provide a proper perspective of the underlying data. The method concludes with the rendering of the data from the data grid corresponding to the selected data portion, at the viewport region of the containment window.

As can be seen, the various embodiments of the invention provide an easy and effective navigation tool to navigate a large data grid using minimap functionality. The various features defined in the minimap region enables fast and precise access to the desired data in the data grid, thereby enriching a user's navigation experience.

It will be obvious, however, to one skilled in the art, that the present invention may be practiced without some or all of these specific details. In other instances, well known process operations have not been described in detail in order not to unnecessarily obscure the present invention.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention could employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A computer readable medium having computer-executable instructions defining a navigation tool stored thereon which, when executed, display a graphical user interface (GUI) enabling navigation in a data grid, the GUI comprising:
a first region of the GUI to render data from a first data grid, the first data grid comprising a plurality of rows and columns of data representing a portion of the data in the data grid represented by corresponding row and column coordinates;
a second region within the GUI providing a smaller visual representation of the data in the data grid, the second region including a second data grid with a plurality of rows and columns representing a portion of the data in the data grid, each data portion of the second data grid representing a viewable page of data in the first region, wherein each data portion is defined by a corresponding row and column in the first data grid; and
a thumb tool within the second region to enable selection and navigation to a selected data portion in the second data grid at the second region, the navigation to the selected row and column in a data portion in the second region enabling rendering of a corresponding page of data in the first region starting with the selected row and column coordinates,
wherein each of the data portion in the second data grid at the second region providing a preview of the data contained therein prior to the actual navigation to the selected data and wherein the data in the first data grid is a subset of the data in the second data grid and the data in the second data grid is a subset of the data in the data grid.

2. The GUI of claim 1, wherein a size of the second region and the thumb tool remain fixed during resizing of the first region or a containment window.

3. The GUI of claim 1, wherein the thumb tool is configured to lock on to one of a selected row or a selected column of the second data grid in the second region enabling horizontal and vertical navigation within the selected data row or column in the second region.

4. The GUI of claim 1, wherein the density of the second data grid within the second region dynamically adjusts to reflect viewable data selected from the data grid.

5. The GUI of claim 1, further includes customizing the second region of the GUI based on underlying data of the data grid.

6. The GUI of claim 1, further includes automatic scrolling of columns and rows in the second data grid of the second region to enable viewing of data beyond a rendered portion of the second region.

7. The GUI of claim 1, further includes providing labels to each data in the second data grid at the second region to enable identification of the data during navigation.

8. The GUI of claim 7, further includes switching a rendering location for a label for the selected data based on a location of the selected data in the second data grid and a location of the thumb tool in the second region.

9. The GUI of claim 1, wherein navigation to the selected data in the second region is accomplished by one of dragging the thumb tool to the selected data location in the data grid or by clicking at a selected location on a background of the data grid.

10. The GUI of claim 9, wherein the drag operation can be one of live operation or delayed operation, the live drag operation enables immediate scrolling of data in the first region to reflect the data in the selected data portion of the second region while the thumb tool is engaged and the delayed operation enables scrolling of data in the first region after a thumb tool is disengaged.

11. A computer readable medium having computer-executable instructions stored thereon which, when executed, display a graphical user interface (GUI) enabling navigation in a data grid, the GUI comprising:
a minimap region for rendering at least a portion of data from the data grid in a two-dimensional grid with a plurality of data portions, wherein the data in the data grid is associated with at least a pair of coordinates to define location of data within the data grid, each of the plurality of data portions storing a page of data from the data grid for rendering at a viewport region in a two-dimensional grid when selected; and
a data relocation tool defined within the minimap region configured to select and provide navigation to any selected data portion rendered in the minimap region, the data relocation tool using the coordinates to identify location of the data portion and to provide the navigation, the navigation to selected coordinates in the data portion in the minimap region enabling rendering of the corresponding page of data from the selected data portion at the viewport region starting with the selected row and column coordinates.

12. The GUI of claim 11, wherein each of the data portions in the two-dimensional grid at the minimap region provides a preview of the data contained therein prior to the actual navigation to the selected data.

13. The GUI of claim 11, further includes filtering of data in the data grid based on one or more filtering options, the filtering enabling hiding of one or more rows or columns in the data grid when being rendered at the two-dimensional grid in the minimap region.

14. The GUI of claim 11, wherein the minimap region is located at one of inside or outside of the viewport region.

15. The GUI of claim 14, wherein when the minimap region is located inside the viewport region, the minimap region is located anywhere within the viewport region.

16. The GUI of claim 11, wherein the minimap region and the data relocation tool remain fixed in size during resizing of the viewport region or a containing window in which the viewport region, the minimap region and the data relocation tool are rendered.

17. The GUI of claim 11, wherein the data grid is one of a spread sheet, data tables, TV listings grid, and a two dimensional array of images.

18. A method for navigating in a data grid, comprising:
defining a minimap region within a containment window of a computing system for rendering at least a portion of data in the data grid, the minimap region rendering the data in a two-dimensional grid with a plurality of data portions, each of the plurality of data portions in the minimap region representing a viewable page of data in the data grid, each of the plurality of data portions defined by a corresponding row and column in the data grid, wherein each of the plurality of data portions provides a preview of data contained therein;
defining a thumb tool within the minimap region to select and navigate to a selected data portion rendered within the minimap region, the navigation to the selected row and column in the data portion enabling rendering of a corresponding page of data in a viewport region the data in the viewport region represented by corresponding row and column coordinates; and
rendering corresponding data from a selected data portion of the minimap region at a viewport region within the containment window upon selection and navigation, the rendering of data in the viewport region being two-dimensional starting with the selected row and column coordinates,
wherein the minimap region provides a smaller visual representation of the data in the data grid.

19. The method of claim 18, further includes providing preview of data at the selected data portion of the minimap region prior to navigating to the selected data portion.

20. The method of claim 18, further includes scaling a size of the minimap region and the thumb tool based on the resizing of the viewport region or a containing window within which the viewport region, minimap region and the thumb tool is rendered.

21. The method of claim 18, further includes enabling horizontal and vertical navigation within the minimap region by providing a locking mechanism within the thumb tool to lock into one of a selected row or a selected column of the data rendered in the minimap region for navigation.

22. The method of claim 18, further includes providing automatic scrolling of rows and columns in the minimap region to view data beyond a rendered portion of the minimap region.

23. The method of claim 18, wherein the minimap region is defined at one of a region outside the viewport region or within the viewport region.
